(19) United States
(12) Patent Application Publication
(10) Pub. No.: US 2016/0252077 A1
(43) Pub. Date: Sep. 1, 2016

(54) TRANSMISSION SYSTEM FOR ROTORS OF WIND DRIVEN ELECTRIC GENERATORS WITH VERTICAL AXIS

(71) Applicants: Orlando LOZZI, Torino (IT); GENIUS S.R.L., Brescia (IT)

(72) Inventor: Orlando Lozzi, Brescia (IT)

(21) Appl. No.: 15/028,184

(22) PCT Filed: Oct. 11, 2013
(86) PCT No.: PCT/IB2013/002283

§ 371 Date: Apr. 8, 2016

(51) Int. Cl. F03D 15/20; F03D 80/70; F03D 9/00; F03D 3/00; F03D 3/06

(52) U.S. Cl. CPC F03D 15/20; F03D 3/005; F03D 3/062; F03D 9/002; F03D 80/70; F05B 2220/30; F05B 2260/403

(57) ABSTRACT

Transmission system with three coaxial concentric shafts for wind driven rotors with vertical axis, characterized by very high compactness and rigidity; it comprises a first outer, blade-carrying, shaft (3) which transmits the rotary motion to the third inner shaft (5) connected to an electric generator which is also coaxial; a second shaft (4) interposed between the two outer (3) and inner (5) rotary shafts and fixed integral with the supporting frame (8) of the eolic machine. The system has a low rolling friction by virtue of the action of counter springs counteracting the weight of the wind driven rotor.

### TECHNICAL FIELD

The present invention relates to a transmission system for rotors of wind driven electric generators with vertical axis.

### PRIOR ART

In wind driven generators with vertical axis the central shaft that supports the various rotor blades is one of the critical points from the constructive viewpoint, because, if it is dimensioned with a small diameter, under the pulsating action of the wind load it is subject to severe deformations that can cause the whole structure to enter in resonance, thus jeopardizing the stability of the entire wind driven rotor. Some manufacturers, in order to overcome the drawback of this arising of vibrational phenomena, have adopted central shaft with big diameters and in order to increase the inertial torque of the structure have come to use shafts having a remarkable wall thickness.

These constructive solutions required by the need to overcome the aforesaid problems and obtain the necessary rigidity have led as a consequence to the adoption of rolling bearings of remarkable size, with consequent high energy dissipation by friction and consequent cost increase. The rate of energy dissipated in frictions constitutes an extremely negative aspect, particularly at the stage of starting the wind driven rotor, which therefore requires considerable wind speeds that are not always available in the majority of installations.

The main object of the present invention is to overcome these negative aspects that sometimes may even prevent use of wind driven rotors with vertical axis.

A further object of the invention is to provide a rotary motion transmission system for wind driven rotors with vertical axis that overcomes the drawbacks of the prior art and can be manufactured at convenient costs, so that it can be produced industrially on a large scale at competitive costs.

### SUMMARY OF THE INVENTION

According to the invention the rotary motion transmission system for wind driven rotors advantageously comprises three concentric shaft the first one and the third one of which, the outer one and the inner one, respectively, are rotatable in order to transmit motion from the wind driven rotor blades to the shaft of a wind driven electric generator and the second one is fixed and integral with a supporting structure which is in turn fixed to the ground.

Advantageously, according to the invention the three shafts are moreover concentric and co-axial. Advantageously, still according to the invention the first outer shaft is integral with the blades of the wind driven generator and rotates outside the second fixed shaft and the third inner rotary shaft rotates inside the second fixed shaft.

### BRIEF DESCRIPTION OF THE DRAWINGS

A preferred embodiment is provided by way of non-limiting example with reference to the attached drawings, in which:

FIG. 1 is a side view of the transmission system according to the invention in an operating position;

FIG. 2 is a sectional view along a longitudinal plane Y-Y of the transmission system of FIG. 1.

### DESCRIPTION OF A PREFERRED EMBODIMENT

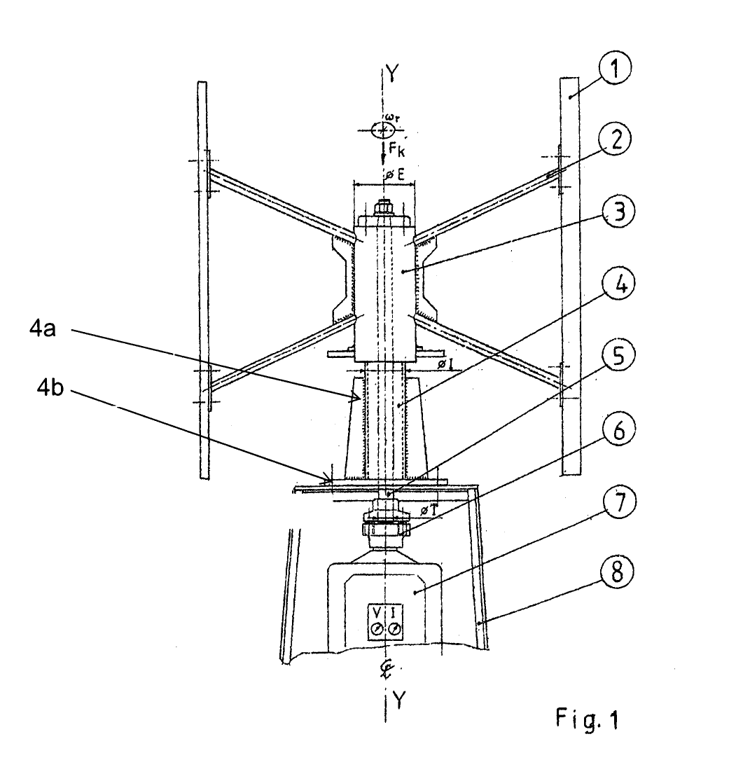

FIG. 1 is a schematic illustration of the configuration of the rotary motion transmission system for wind driven rotors with vertical axis according to the invention.

Reference numeral 3 identifies a first outer rotary shaft with diameter ØE to which radial arms 2 of the blades 1 of a wind driven rotor with vertical axis are attached.

Reference numeral 4 identifies a second shaft with diameter ØI which is attached to the frame 8, has a remarkable diameter and is stiffened by ribs 4a that end on a lower support disc 4b of big size integral with the frame 8.

A third inner rotary shaft 5 with diameter ØC receives the rotary motion from the outer shaft 3 and, according to the invention, is advantageously biased only by the torque generated by the transmission of the rotary motion of the blades 2 and for this reason it requires small size.

According to the invention the diameters of the shafts 3,4,5 meet the following condition ØC<ØI<ØE.

This structural configuration has very high rigidity, both flexional and torsional, with respect to outer loads.

In the embodiment shown the first shaft 3 is also shorter than the other two shafts 4 and 5.

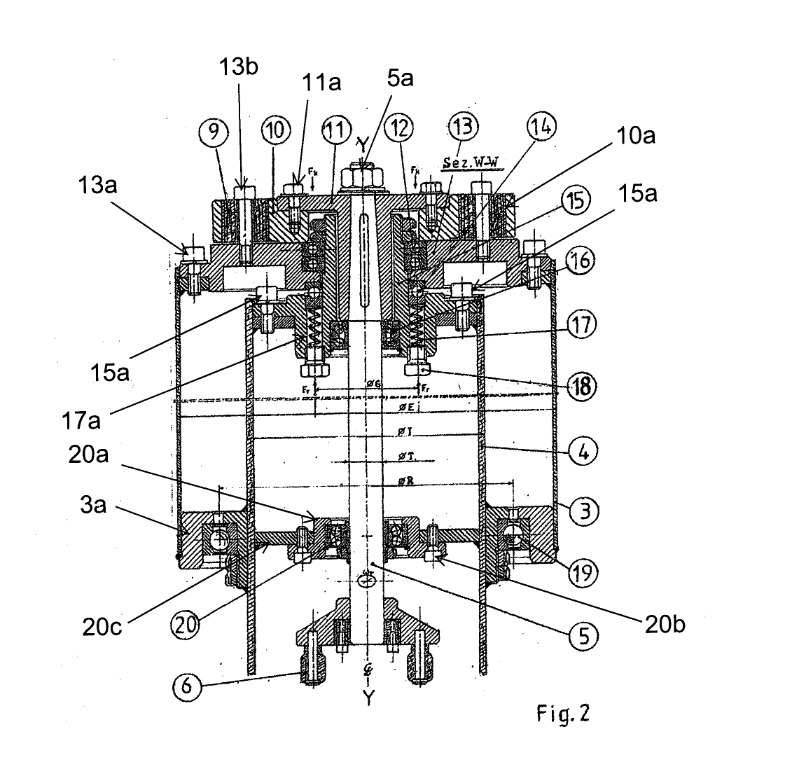

FIG. 2, section Y-Y of FIG. 1, shows more in details the structural configuration of the transmission system according to the invention. The outer rotary shaft 3 has a bearing 19 received in an inner lower seat. Said bearing 19 is preferably received in a seat provided in a ferrule 3a that closes inferiorly the outer rotary shaft 3. According to a preferred embodiment of the invention, the bearing 19 is preferably a ball bearing with ceramic balls and stainless steel tracks immersed in a special lubricant so as to ensure very high slidability and high rigidity. It is to be noted that advantageously, according to the invention, this bearing 19 is exposed to a purely radial load when the transmission system is working, because the axial load component to which the outer rotary shaft 3 is exposed is discharged in an axial bearing 14 arranged superiorly at the opposite end of the shaft 3, relative to the bearing 19. Said bearing 14 is further advantageously supported inferiorly by counter springs 17, onto which the axial load is transferred and which are pre-loaded by screws 18 engaging in a flange 15 superiorly attached by means of screws 15a to the fixed shaft 4.

In the upper flange 15 there are further received, in suitable seats, first bearings 12 interposed between said flange 15 and a cover 13 upperly closing the outer rotary shaft 3 to which it is attached by means of screws 13a, and second bearings 16 interposed between said flange 15 and the inner rotary shaft 5. Said flange 15 further houses, in suitable axial seats 17a, the counter springs 17 pre-loaded by the screws 18 engaged in the flange 15.

According to the invention, the shaft 4, being fixed on the frame 8, can be advantageously built also with remarkable thickness, thus forming a highly rigid structure, without jeopardizing the fluidity of working of the transmission system.

Also the bearings 12, which can advantageously be of small diameter, are axially discharged, whereby the wind driven rotor attached to the shaft 3 and comprising the blades 1 and the arms 2, while being of remarkable size and having very high rigidity, is a system with very low dissipative friction.

According to the invention a flexible coupling is preferably provided interposed between the first outer rotary shaft 3 and the third inner rotary shaft 5. More precisely, on the upper end of the inner rotary shaft 5 there is fitted a flange 11 which is superiorly secured to the shaft 5 by means of a locking nut 5a. The flange 11 is further bolted, by means of screws 11a, to a counter flange 10 housing, in suitable seats 10a, elastic elements 9, for instance silent-blocks made of rubber, that are made integral with the cover 13, upperly closing the outer rotary shaft 3, by means of screws 13b passing through the elastic elements, for instance silent-blocks, 9 and engaged in the cover 13.

Fitted on the lower end of the inner rotary shaft 5 there is provided a flexible coupling 6, through which the rotary motion is transmitted from the inner rotary shaft 5 to the electric generator 7. The generator 7 is further preferably mounted coaxial with the inner rotary shaft 5. The inner rotary shaft 5 is advantageously of small diameter and slides on upper bearings 16 and lower bearings 20 received in lower flange 20a attached by means of screws 20b to a radial partition 20c that partially closes the lower end of the fixed shaft 4. In this way, advantageously, a system with very low dissipative friction, similarly to what happens with the outer rotary shaft 3, is obtained.

This arrangement of three coaxial concentric shafts results in a very rigid cinematic mechanism, as required for applications in wind driven rotors with vertical axis, but at the same time the cinematic mechanism with very low dissipation allows easy starting of the wind driven rotor also for very low wind speeds.

The transmission system as described and illustrated can be subject to several variants and modifications falling within the same inventive principle.

1. Transmission system for rotors of wind driven electric generators with vertical axis, characterized in that it comprises three coaxial concentric shafts, of which a first outer rotary shaft (3) integral with the blades (1) of the wind driven rotor, a second shaft (4) fixed on a supporting frame (8) and a third inner rotary shaft (5) integral with the first shaft (3) and with a rotary shaft of an electric generator (7), said first (3) and third (5) rotary shafts having the function of transmitting the rotary motion from the blades (1) of the wind driven rotor to the shaft of the electric generator (7) and said second shaft (4) having the function of supporting the transmission system.

2. System according to claim 1, wherein the first outer rotary shaft (3) has a diameter ØE, the second fixed shaft (4) has a diameter ØI, the third inner rotary shaft (5) has a diameter ØC and wherein ØC<ØI<ØE.

3. System according to claim 1, wherein the outer rotary shaft (3) is stiffened by ribs (4a) that end on a lower support disc (4b) integral with the frame (8).

4. System according to claim 1, wherein the outer rotary shaft (3) has a bearing (19) received in an inner lower seat, said bearing (19) being exposed to a purely radial load when the transmission system is working.

5. System according to claim 4, wherein, when the system is working, the axial load component to which the outer rotary shaft (3) is exposed, is discharged in an axial bearing (14) arranged superiorly at the opposite end of the shaft (3), relative to the bearing (19).

6. System according to claim 5, wherein said bearing (14) is further supported inferiorly by counter springs (17) pre-loaded by screws (18) engaging in a flange (15) superiorly attached by means of screws (15a) to the fixed shaft (4).

7. System according to claim 6, wherein in the upper flange (15) there are further received, in suitable seats, first bearings (12) interposed between said flange (15) and a cover (13) upperly closing the outer rotary shaft (3) and second bearings (16) interposed between said flange (15) and the inner rotary shaft (5).

8. System according to claim 1, wherein a flexible coupling (9) is provided interposed between the first outer rotary shaft (3) and the third inner rotary shaft (5).

9. System according to claim 8, wherein on the upper end of the inner rotary shaft (5) there is fitted a flange (11) which is superiorly secured to the inner rotary shaft (5) by means of a locking nut (5a).

10. System according to claim 9, wherein the flange (11) is further bolted, by means of screws (11a), to a counter flange (10) housing, in suitable seats (10a), elastic elements (9) that are made integral with the cover (13), upperly closing the outer rotary shaft (3), by means of screws (13b) passing through the elastic elements (9) and engaged in the cover (13).

11. System according to claim 10, wherein said elastic elements (9) comprise silent-blocks made of rubber.

12. System according to claim 1, wherein fitted on the lower end of the inner rotary shaft (5) there is provided a flexible coupling (6), through which the rotary motion is transmitted from the inner rotary shaft (5) to the electric generator (7).

13. System according to claim 1, wherein the inner rotary shaft (5) slides on upper bearings (16) and lower bearings (20) received in lower flange (20a) attached by means of screws (20b) to a radial partition (20c) that partially closes the lower end of the fixed shaft (4).

14. System according to claim 1, wherein the first rotary shaft (3) rotates outside the second fixed shaft (4).

15. System according to claim 1, wherein the electric generator (7) is mounted coaxial with the third rotary shaft (5).
